(19) United States
(12) Patent Application Publication
(10) Pub. No.: US 2010/0296083 A1
(43) Pub. Date: Nov. 25, 2010

(54) Detection and identification of solid matter

(75) Inventors: Chandra Kumar Naranbhai Patel, Los Angeles, CA (US); Anadi Mukherjee, Los Angeles, CA (US)

Correspondence Address: Cislo & Thomas LLP, 1333 2nd Street, Suite #500, Santa Monica, CA, 90401-4110, US

(73) Assignee: Pranalytica, Inc.

(21) Appl. No.: 12/316,291

(22) Filed: Dec. 9, 2008

Related U.S. Application Data
(63) Continuation-in-part of application No. 12/069,791, filed on Feb. 12, 2008.

(51) Int. Cl. G01N 21/01

(52) U.S. Cl. 356/237.3

(57) ABSTRACT

Detection and identification of minute quantities of condensed or solid state materials with significantly improved performance over the present state-of-the-art, comprises illuminating a small target particle with an appropriate laser radiation at a wavelength that is strongly absorbed by the target. The resulting temperature rise is observed by monitoring the increased blackbody radiation from the sample. An unambiguous determination of the target compound or the target material composition can be achieved through the use of a tunable laser that generates an absorption fingerprint of the target.

### CROSS-REFERENCES TO RELATED APPLICATIONS

This document is a Continuation-in-Part patent application which is related to, and claims the priority through earlier filed U.S. Utility patent application Ser. No. 12/069,791, filed on Feb. 12, 2008, all the subject matter of which is herein incorporated by this reference thereto in its entirety for all purposes.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever. 37 C.F.R. §1.71(d).

### BACKGROUND OF THE INVENTION

1. Field of the Invention

This invention relates to methods of detection and identification of solid matter, and more particularly and practically to such methods for the non-destructive and/or non-contact detection and identification of miniscule quantities of solids.

2. Description of the Related Art

High sensitivity optical detection of gases, especially for point detection, has made significant advances in recent times using tunable laser based spectroscopic techniques (see D. Weidmann, F. K. Tittel, T. Aellen, M. Beck, D. Hofstetter, J. Faist and S. Blaser, “Mid-infrared Trace-gas Sensing with a Quasi-continuous-wave Peltier-cooled Distributed Feedback Quantum Cascade Laser”, Appl. Phys. B 79, 907-913 (2004); G. Wysocky, A. A. Kosterev and F. K. Tittel, “Spectroscopic Trace-gas Sensor with Rapidly Scanned Wavelengths of a Pulsed Quantum Cascade Laser for in-situ NO monitoring of Industrial Exhaust Systems”, Appl. Phys. B 80, 617-625 (2005); and G. Wysocky, R. F. Curl, F. K. Tittel, R. Maulini, J. M. Bulliard and J. Faist, “Widely Tunable Mode-hop Free External Cavity Quantum Cascade Laser for High Resolution Spectroscopic Applications”, Appl. Phys. B 81, 769-777 (2005)). Of these, the use of photoacoustic detection, because of its inherent ruggedness and exquisite sensitivity, has been deployed in commercial sensors for the detection of trace gases (see M. B. Pushkarsky, M. E. Webber, O. Baghdassarian, L. R. Narasimhan and C. Kumar N. Patel, “Laser Based Photoacoustic Ammonia Sensors for Industrial Applications”, Applied Physics B 75, 391-396 (2002) and M. E. Webber, T. Macdonald, M. B. Pushkarsky, C. Kumar N. Patel, Yongling Zhao, Nichole Marcillac ang F. M. Mitloehner, “Agricultural Ammonia Sensor using Diode Lasers and Photoacoustic Spectroscopy”, Measurement Science and Technology 16, 1547-1553 (2005)) and these sensors are being developed for the detection of chemical warfare agents (see M. E. Webber, M. B. Pushkarsky and C, Kumar N. Patel, “Optical Detection of Chemical Warfare Agents and Toxic Industrial Chemical: Simulation”, J. Appl. Phys. 97, 113101 (2005); M. B. Pushkarsky, M. E. Webber, Tyson Macdonald and C. Kumar N. Patel, “High-sensitivity, high-selectivity detection of chemical warfare agents”, Applied Physics Letters 88, 044103 (2006) and Anadi Mukherjee, Ilya Dunayevskiy, Manu Prasanna, Rowel Go, Alexei Tsekoun, Xiaojun Wang, Jenyu Fan and C. Kumar N. Patel, “Sub-ppb Level Detection of Dimethyl Methyl Phosphonate (DMMP) Using Quantum Cascade Laser Photoacoustic Spectroscopy”, Applied Optics 47, 1543 (2008)) (CWAs), explosives vapors (see Michael Pushkarsky, Ilya Dunayevskiy, Manu Prasanna, Alexei Tsekoun, Rowel Go and C. Kumar N. Patel, “Sensitive Detection of TNT”, Proc. Nat. Acad. Sciences 103, 19630-19634 (2006) and Ilya Dunayevskiy, Alexei Tsekoun, Manu Prasanna, Rowel Go and C. Kumar N. Patel, “High Sensitivity Detection of Triacetone Triperoxide (TATP) and Its Precursor Acetone”, Applied Optics 46, 6397-6404 (2007)) and toxic industrial chemicals (TICs) in defense and homeland security applications. Typical demonstrated sensitivities are at a ppb (parts per billion) level with false alarm rates (false positives) approaching 1:107. Standoff detection of explosives vapors, CWAs and TICs has been recently proposed using a remote optothermal sensor (ROSE) as set forth in related U.S. patent application Ser. No. 12/069,791 filed Feb. 12, 2008 entitled Remote Optothermal Sensor (ROSE) Standoff Detection of CWAs, Explosives Vapors And TICs filed by the present inventors and incorporated herein in its entirety by this reference thereto.

ROSE promises a detection capability of ppb level clouds (10 meters diameter) of the target gaseous substances at distances approaching a kilometer. However, there have been very few significant advances in the optical detection of trace solid particulate matter consisting of explosives and other dangerous substances. Additionally, photothermal radiometry using fixed frequency lasers has been described for deep-level spectroscopy of semiconductors. (See, for example, A. Mandelis, “Photothermal Analysis of Thermal Properties of Solids”, J. Thermal Anal. 37, 1065-1101, 1991.)

While laboratory techniques exist for the analysis of minute amounts of solid material using a variety of techniques that involve the conversion of the solid into vapors and subsequent analysis using mass spectrometric or other techniques, these are not readily applicable and/or convenient for use in many real world environments. A commonly used scheme, deployed for airport security screening, involves the collection of the trace dangerous particle on a grid of some sort and heating the material to convert into vapors for analysis using ion mobility spectrometer. This technique requires an operator swiping a “swab” over the suspected surface and carrying the swab to the IMS instrument for analysis. (See K. Cottingham, “Ion Mobility Spectrometry rediscovered”, Product Review, Analytical Chemistry, October 1, p 435A, 2003; G. Ewing, D. A. Atkinson. G. A. Eichman and G. J. Ewing, “A critical review of ion mobility spectrometry for the detection of explosives and explosive related compounds”, Talanta 54, 515-529, (2001); and Abu B. Kanu, Prabha Dwivedi, Maggie Tam, Laura Matz and Herbert H. Hill Jr., “Special Feature: Perspective on Ion mobility-mass spectrometry”, J. of Mass Spectrometry 43, 1-22 (2008)). This method, though widely deployed at airports (see, VaporTracer from GE Industrial (www.geindustrial.com/ge-interlogix/iontrack); IONSCAN 400B from Smiths Detection (www.smithsdetection.com)), suffers from low probability of detection and high probability of false alarms, and is limited to examining only a small number of objects.

Due to the inherent deficiencies and limited applicability of the currently used methods, there is a need for a more reliable and efficient technique for examining a variety of objects in real time, and for detecting and identifying minute amounts of solid particulate matter rapidly, without operator intervention. This is particularly necessary for the detection of hazardous material, and in order to increase the level of safety that is demanded at, for example airports, in increasing turbulent times.

### SUMMARY OF THE INVENTION

In view of the foregoing disadvantages inherent in the known methods of detecting solid particulate matter now present in the prior art, the present invention provides a new method of high sensitivity detection of solid/condensed state matter, which is especially useful for detection of minute amounts of material with a high degree of specificity and confidence. In addition, the inventive method is both non-contact and minimally invasive.

The method of the present invention involves illuminating a small target particle with an appropriate laser radiation at a wavelength that is strongly absorbed by the target. The resulting temperature rise is observed by monitoring the increased blackbody radiation from the sample. Through the use of a tunable laser, the identity of the target material composition is determined by generating an absorption fingerprint of the target, and correlating it to a predetermined absorption fingerprint associated with the material.

The method of the present invention can be used for a wide variety of applications, including detecting and identifying explosives material residue on persons who may have handled these dangerous materials, for example, in providing security in airports and other facilities which require increased security.

### OBJECTS OF THE INVENTION

It is an object of the present invention to provide a system and method for the detection of a target substance.

It is another object of the invention to provide such a system and method which enables identification of the target substance, or identification of at least one constituent of a target substance including more than one constituents.

It is another object of the invention to provide such a system and method utilizing a laser system which may include a tunable laser system.

It is another object to provide such a system or method for detecting minute amounts of solid particulate matter, which may be in the order of a picogram in quantity, and as small as a few micrometers in size.

It is another object of the invention to provide an efficient nondestructive and/or noncontact system and method for examining a large number of objects for solid particulate matter.

The foregoing objects are some of but a few of the goals sought to be attained by the present invention and are set forth for the purposes of example only and not those of limitation.

### BRIEF DESCRIPTION OF THE DRAWINGS

FIG. 1 is an equipment schematic for the detection of a target material, according to a representative embodiment of the present invention.

FIG. 2 is a graph depicting infrared absorption characteristics of a target sample having a peak absorption frequency at a wavelength of 7400 nm.

FIG. 3 is a spatial x-y scan of the local temperature recorded by an infrared camera, for a sample illuminated at its peak temperature of absorption. The location of the temperature rise indicates the location of the sample.

FIG. 4 is a spatial x-y scan of the local temperature recorded by an infrared camera, for a sample such as in FIG. 3, wherein the sample is illuminated with radiation that is only weakly absorbed by the sample (i.e., in tail of the absorption feature).

FIG. 5 is an infrared photograph of a radiating PbS particle on a KCl substrate.

FIG. 6 is an expanded view of the PbS particle of FIG. 5, showing that it occupies only pixel of the camera.

FIG. 7 is a three dimensional graph illustrating the detection of a PbS particle.

FIG. 8 shows a line scan of the graph of FIG. 7 in the x-y plane along the y direction for x=181.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

This disclosure describes a novel method for the detection of certain solid particulate matter, including the detection of minute particles, at distances of approximately a meter or less. The method is directly applicable to nondestructive and/or noncontact detection of explosive residues on moderately soft supporting structures such as briefcases and personal clothing.

A capability of detecting and identifying isolated and/or individual particles as small as a few nanograms is shown experimentally. Theoretical analysis supports experimental observation and indicates that with optimized detectors and data processing algorithms, the measurement capability can be improved significantly, permitting nondestructive and/or noncontact analysis of picogram quantity of the target material. With the availability of high power, room temperature, tunable mid wave infrared (MWIR) and long wave infrared (LWIR) lasers, this technology may play an important role in detecting and identifying explosives material residue on persons who may have handled these dangerous materials.

Detection and identification of the particulate matter, according to the method described herein, is based on the spatial temperature differences produced when a solid object is illuminated with infrared radiation. Most, if not all, objects have wavelength dependent radiation absorption characteristics. This enables identification of the object using a tunable laser, and further enables discrimination between a background and the object.

A practical example of this situation is a briefcase or other object on which an individual has left trace materials during the handling of explosives. On most surfaces, other than highly thermally conductive surfaces, the deposited target material will show a measurable temperature rise when illuminated by radiation that is absorbed by the target. The temperature rise manifests itself into an increased blackbody radiation emitted from the heated particle and can be readily detected using a broadband detector. Other areas, where the absorbing target sample is not present, will not show such rise in temperature. (There may be some minimal temperature rise in the surface where the substance is not present. Therefore, the target can be detected by detection of a significantly higher temperature rise, or temperature rise differential). By using different radiation wavelengths, the target substance can be unambiguously detected and identified. The spatially localized temperature rise can be detected by a variety of methods including the use of an infrared camera.

Thus, the system or method of the present invention can be used for analysis of a target substance comprising one, or more than one constituents, and can be used for detecting the presence or absence, identifying, and/or locating the target substance or at least one of its constituents.

The system of the present invention comprises a laser system capable of generating at least one wavelength of interest for a target substance, which is adapted for illuminating a surface including the substance or a suspected substance. The wavelength of interest is at or near an absorption wavelength characteristic of the target substance, such that when said surface is illuminated, a significantly noticeable localized temperature differential, typically a temperature increase or peak, indicates the presence of the target substance. A heat sensor detects heat generated by the surface after the surface is illuminated, such that the presence of the target substance is at least partially detectable in the surface based on the heat generated.

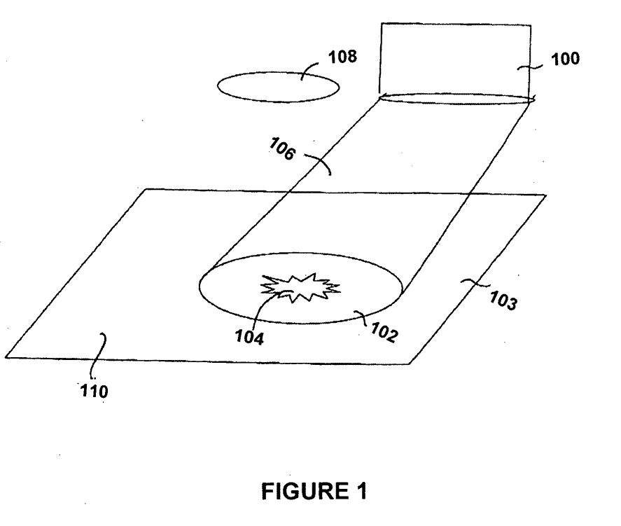

An equipment schematic is shown in FIG. 1 and involves providing a laser 100 for illuminating an area 102 on a surface 110 including a target material 104 with a laser beam 106 that is absorbed by the material 104. The absorption of the laser radiation causes a temperature increase in the target material 104, which is greater than the temperature rise in the surrounding area where the material is not present. A heat sensor 108, such as an IR camera, is used to detect the spatial temperature rise of the area 102.

In order to identify an unknown sample, a tunable laser is used to illuminate the sample at various frequencies, until the frequency of peak absorption is determined according to the detected peak temperature rise. The laser can be tunable continuously, at discrete intervals, or both. The determined frequency of peak absorption can then be correlated to the identity of the material having the detected frequency of absorption. Additionally, the method may be used to detect or confirm the presence or location of a suspected substance by radiating the surface with the absorption wavelength of that substance. The system and method of the invention can also be used for identifying and/or detecting individual components of a sample having more than one component.

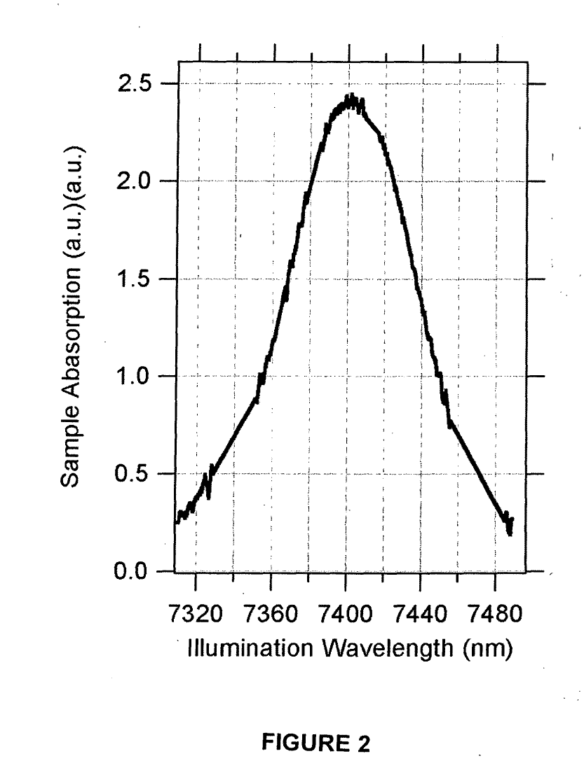

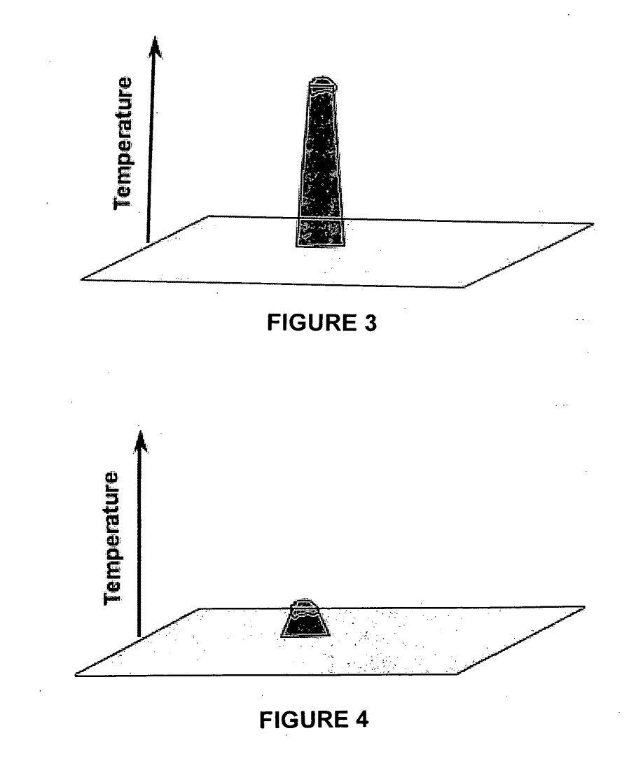

FIG. 2 is a graph showing the expected infrared absorption characteristics of a target sample having a peak absorption frequency at a wavelength of 7400 nm. Based on the peak frequency, a spatial x-y scan of the local temperature recorded by an infrared camera can be generated, as shown in FIG. 3, wherein a temperature rise would be observed only where the sample is located. If the sample were to be illuminated at a wavelength of say 7320 nm, where the absorption is much smaller than that at the peak (7400 nm), an x-y scan as shown in FIG. 4, having a much smaller temperature rise at the sample location, would be expected. Thus, the spatial dependence of the temperature rise shows the location of the target, and the wavelength dependence of the temperature rise enables unique identification of the target substance, even in the presence of other absorbers.

This method of detection and identification could involve, for example, the collection of samples from surfaces such as briefcase and other items, using a swab, or direct testing of the surface, for analysis of the particulates which may be present. The method assures not only detection but will also provide unambiguous identification of the substance of the target particles and immunity from false alarms, as the ability to tune the illuminating laser wavelength allows differentiation by identifying the fingerprints of different substances.

### Estimate of Temperature Rise of a Particle and Detection Limits

An analysis of the expected temperature rise for hypothetical particles having the absorption spectrum shown in FIG. 2, with peak absorption of ˜10³ cm⁻¹, was carried out. The analysis has been carried for a general case with an arbitrary substrate. When the particle is exposed to radiation at the peak of the absorption feature, its temperature will rise. The absorbed heat is lost from the particle by conduction to the substrate material on which the particle is located as well as through blackbody radiation. The heat lost by radiation will be detected by a thermal imaging camera sensor.

The heat equation, as provided below, is analyzed for determination of the temperature rise of a particular particle:

$$C \frac{\partial T}{\partial t} = - div J + E \qquad ( 0.1 )$$

where T is the temperature, C is the heat capacity, J is the flux of heat flow and E is the laser energy absorbed per unit volume per second (source term). Here J=−K∇T, where K is the thermal conductivity. Thus, equation (0.1) takes the form of a regular diffusion equation:

$${∇}^{2} T = \frac{1}{κ} \frac{\partial T}{\partial t} - \frac{E}{K} \qquad ( 0.2 )$$

where the thermal diffusivity κ=K/C=K/ρc where ρ is the density and c is the specific heat per unit mass. Solution of equation (0.2) holds all the information needed both in steady state (laser not chopped) and time dependent (chopped laser) cases. In the steady-state, equation (0.2) reduces to Poisson's equation:

$${∇}^{2} T = - \frac{E}{K} \qquad ( 0.3 )$$

The energy absorbed per unit volume per second is E−intensity×absorption=1×e^{-αz},

where I is the Gaussian intensity of the laser beam

$$I = {I}_{0} {e}^{- ( {r}^{2} / {w}^{2} )} ,$$

z is the depth coordinate, r is the radial coordinate and w is the beam spot size. Using the radial (i.e. cylindrical) symmetry of Gaussian laser beams, equation (0.3) can be solved by Bessel transform. (See M. Lax, “Temperature Rise Induced by a Laser Beam” J. Appl. Phys. 48, pp. 3919-3924 (1977) for the complete solution.)

$$T ( R , Z , W ) = B {\int }_{0}^{∞} {J}_{0} ( λ R ) F ( λ ) \frac{W {e}^{- λ z} - {λe}^{- Wz}}{{W}^{2} - {λ}^{2}} d λ \qquad ( 0.4 )$$

where the dimensionless parameters are R=r/w, Z=z/w, W=αw, B=αP/2πKF(0) and P=total incident power of the laser beam. The Gaussian function F(R)=e^{-R}^{²} and F(λ) is the Bessel transform of F(R). This can be interpreted as the increase in temperature due to the absorption of the laser beam, since one may also add a solution T=const which obeys the differential equation (0.3) and the boundary conditions.

The general solution for the temperature shown in equation (0.4) can be rewritten in terms of a normalized temperature rise function N(R, Z, W) and the maximum temperature rise as:

ΔT(R,Z,W)=δTₘₐₓN(R,Z,W) (0.5)

where the maximum temperature rise is

$$δ {T}_{max} = \frac{P}{2 \sqrt{π} K w} \qquad ( 0.6 )$$

See M. Lax, “Temperature Rise Induced by a Laser Beam” J. Appl. Phys. 48, pp. 3919-3924 (1977).

Assuming heating is confined to the surface layer only (i.e. W→∞). (See M. Lax, “Temperature Rise Induced by a Laser Beam” J. Appl. Phys. 48, pp. 3919-3924 (1977)). The general expression of the function N(R, Z, W) has been shown to be:

$$N ( R , Z , W ) = \frac{W}{{\int }_{0}^{∞} F ( λ ) d λ} {\int }_{0}^{∞} {J}_{0} ( λ R ) F ( λ ) \frac{\begin{matrix}W {e}^{- λ Z} - \\ {λe}^{- WZ}\end{matrix}}{{W}^{2} - {λ}^{2}} d λ \qquad ( 0.7 )$$

where F(λ) is the Bessel transform of F(R).

To determine the temperature rise on the target particle along the beam axis (i.e. R=0) and at the front surface (i.e. Z=0), we write the realistic temperature on the beam axis and at the front surface to be the maximum temperature times the reduction factor N because of finite penetration depth as:

$$\begin{matrix}Δ T ( 0 , 0 , W ) = δ {T}_{max} N ( 0 , 0 , W ) \\ where & ( 0.8 ) \\ N ( 0 , 0 , W ) = \frac{1}{\sqrt{π}} {\int }_{0}^{∞} {e}^{- \frac{{λ}^{2}}{4}} ( \frac{W}{W + λ} ) d λ & ( 0.9 )\end{matrix}$$

Equation (0.9) has been solved by Lax (see M. Lax, “Temperature Rise Induced by a Laser Beam” J. Appl. Phys. 48, pp. 3919-3924 (1977) in terms of Dawson and exponential integrals and the solution for large W is:

N(0,0,W)→1 for large W (0.10)

For a 50 μm PbS particle with α=30,000 cm⁻¹ at 1.55 μm and a beam spot size 2 mm we have W≈6,000. (See G. Guizetti and A. Borghesi, “Lead Sulfide” in Handbook of Optical Constants of Solids (Academic Press, 1998, Ed. Edward D. Palik) p 532.) This ensures that the entire 1.55 μm laser beam is absorbed by the PbS particle and thus N(0,0,W)≈1. This is also true for TNT particles with α=1000 cm⁻¹ at 7.4 μm and a beam spot size 2 mm will have W=200. Using this in equation (0.6) we have the expression for the rise in temperature in explosive particles:

$$Δ T = \frac{P}{2 \sqrt{π} K w} \qquad ( 0.11 )$$

Here the total incident power is P is in Watts, thermal conductivity K is in W/m⁻¹K⁻¹ and the beam radius w is in meters.

### Example for Detection of a PbS Particle

For this example, the behavior of a PbS particle using a 1.55 μm laser is analyzed. The absorption coefficient of PbS at 1.55 μm is ˜3×10⁴ cm⁻¹ (see G. Guizetti and A. Borghesi, “Lead Sulfide” in Handbook of Optical Constants of Solids (Academic Press, 1998, Ed. Edward D. Palik) p 532). This ensures that the entire 1.55 μm laser beam is absorbed by a typical 50 μm PbS particle. The calculated result of ΔT for a 50 μm diameter PbS particle on a KCl substrate (thermal conductivity=3.3 W/m⁻¹K⁻¹) exposed to a 2 mm diameter 200 mW laser beam at 1.55 μm is:

ΔT=0.43 K (0.12)

This temperature should be detectable using commercially available microbolometer IR cameras (with NETD ˜80 mK) as shown in our experimental results given in a later section. Table 1 below gives calculated temperature rise of 10 μm and 50 μm PbS particles on a wide variety of substrates.

TABLE 1
Calculated temperature rise for a 10 μm and 50 μm absorbing
PbS particles on various substrates.

Particle Size

| | Thermal | 10 μm | 50 μm |
|---|---|---|---|
| Substrate Material | Conductivity | ΔT (K) | ΔT (K) |
| Brass | 117 | 2.41E−03 | 1.21E−02 |
| ZnSe | 18 | 1.57E−02 | 7.84E−02 |
| Stainless Steel (304) | 14.6 | 1.93E−02 | 9.66E−02 |
| BaF₂, LiF | 12.56 | 2.25E−02 | 1.12E−01 |
| KCl | 3.3 | 8.55E−02 | 4.27E−01 |
| Plastic Laminate | 0.21 | 1.34E+00 | 6.72E+00 |
| Molded silicone | 0.167 | 1.69E+00 | 8.45E+00 |
| Silicone foam-flexible | 0.167 | 1.69E+00 | 8.45E+00 |
| Silicone- foam - rigid | 0.084 | 3.36E+00 | 1.68E+01 |
| Paper | 0.05 | 5.64E+00 | 2.82E+01 |

The laser power, at 1.55 μm, is 200 mW and the focal spot diameter is 2 mm.

Since the substrate thermal conductivity is an important parameter in the observed temperature rise is seen from equation (0.11), we have evaluated temperature rise for 10 μm and 50 μm PbS particles on a variety of substrates. These temperatures are detectable using commercially available microbolometer IR cameras with a noise equivalent temperature difference (NETD) ˜80 mK as shown in our experimental results.

### SNR Calculations

### Simulation of Pbs Particle Detection Using a LWIR FPA Camera:

In order to calculate the achievable signal to noise ratio (SNR), the noise equivalent power (NEP) of the IR camera is evaluated (see P. W. Kruse, “A Comparison of the Limits to the Performance of Thermal and Photon Detector Imaging Arrays” Infrared Phys. & Technol., 36, pp. 869-882 (1995); P. G. Datskos, N. V. Lavrik and S. Rajic, “Performance of Uncooled Microcantilever Thermal DFetectors” Review of Scientific Instruments, 75, pp. 1134-1148 (2004); and F. J. Crawford, “Electro-Optical Sensors Overview,” IEEE AES Systems Magazine, pp. 17-24, (October, 1998).

$$NEP = \frac{{A}_{det} NETD {τ}_{0} ( \frac{Δ P}{Δ T} )}{4 {F}^{2}} \qquad ( 0.13 )$$

where

$$F = \frac{{f}_{T}}{{d}_{T}}$$

is the f# of the observing optical system having a focal length f_{T} and an aperture d_{T}, A_{det} is the detector area, τ₀ is the optical transmittance of the light collection system, ΔP/ΔT is the thermal derivative of blackbody radiated power across the wavelength of interest λ₁−λ₂. With F=f/#=1, detector pixel size of 38 μm (for the camera used in the experiments described above), NETD=80 mK,

$$\frac{Δ P}{Δ T} = 2.62 \times {10}^{- 4} W {cm}^{- 2} {K}^{- 1}$$

and τ₀=0.8 we obtain:

NEP≈60.5×10⁻¹²W (0.14)

From Stefan-Boltzmann law the power density of radiation of a blackbody is J=εσT⁴ where ε is the emissivity of the particle, σ is the Stefan-Boltzmann constant and T is the temperature of the blackbody in degrees Kelvin. The excess power density radiated by the heated particle with respect to its surroundings (unexposed or detuned from target absorption) is J≈4εσT³ΔT for temperature rise ΔT<<T. The total power radiated spherically in 4π steradians will be P=J×A, where A is the radiating surface area. The fractional power received by the IR camera from its collection optics is then

$$P = \frac{{a}_{T} ɛσ {T}^{3} Δ T ( 0 , 0 , W ) A}{π {D}^{2}} \qquad ( 0.15 )$$

where α_{T} is the aperture area of the lens.

With camera lens aperture of 64 mm, σ=5.67×10⁻⁸ W·m⁻²·K⁻⁴, T=300 K, ΔT=0.43 K, radiating particle diameter of 50 μm and the stand-off distance D=13 cm we obtain:

P≈313.3×10⁻¹² W (0.16)

The SNR achievable using the FPA camera is given by:

$$SNR = \frac{4 π {f}^{2} ɛσ {T}^{3} Δ {T}_{max} ( 0 , 0 , W ) {w}^{2}}{NETD {τ}_{0} ( \frac{Δ P}{Δ T} ) {A}_{det} {D}^{2}} \qquad ( 0.17 )$$

Using the values given above we have:

SNR≈5.2 (0.18)

This calculated value agrees well with the observed SNR (˜5) in the raw image of the PbS particle with the background. A simple image processing technique like full matrix data analysis can be used get a four fold enhancement of SNR (actually demonstrated SNR of ˜20).

Besides background subtraction, careful image processing techniques can be used with the image matrix data to enhance image contrast (e.g. histogram equalization) and therefore enhance the SNR ratio even further. Further, in realistic cases we will have blurring of image due to:

1. Camera movement during capture

2. Finite aperturing and out-of-focus optics

3. Atmospheric turbulence—scattering and time varying refractive index

4. Short exposure time—low number of photons captured

These factors can be handled by evaluating the Point Spread Function (or Optical Transfer Function, the Fourier Transform) of the system. Then a standard deconvolution algorithm (e.g. Lucy-Richardson) will be used to deblur the images to increase the contrast and sharpness. Implementation of all of these processes will result in an enhanced SNR of the captured image by the IR camera.

### Calculation for TNT Detection

The following are calculations for estimation of the size and mass of TNT particles at the lowest detection limit (LDL defined for SNR=1) using the best IR camera/detector presently available. We consider MCT FPA of pixel size 30 mm×30 mm and a NETD=20 mK, a 1 Watt laser QCL beam at 7.4 μm of 1 mm spot diameter on micron and submicron size TNT particles on different realistic substrates (backing materials). The lens, working distance etc., are taken same as that of the FLIR systems model A-40 Researcher camera.

In this case, SNR=P/NEP=1, i.e. P=NEP. Equating equations 0.13 and 0.15 we get:

$$\frac{{a}_{T} ɛσ {T}^{3} Δ T ( 0 , 0 , W ) A}{π {D}^{2}} = \frac{{A}_{det} NETD {τ}_{0} ( \frac{Δ P}{Δ T} )}{4 {F}^{2}} \qquad ( 0.19 )$$

Since the particles are smaller than α⁻¹, we substitute

$$Δ T = \frac{P {e}^{- α d}}{2 \sqrt{π} K w} ,$$

where
α=10³ cm⁻¹,
d is the diameter of the TNT particle,

$$A = 4 π \times {( \frac{d}{2} )}^{2}$$

is the surface area of the radiating TNT particle,
K is the thermal conductivity,

$$w = \frac{d}{2}$$

is the radius of the particle,

$$P = {P}_{inc} \times {( \frac{d}{L} )}^{2}$$

is the power intercepted by the absorbing particle, where

P_{inc} is the total laser power,

and L is the diameter of the laser beam.

Equation 0.19 leads to a transcendental equation in d,

d³e⁻¹⁰⁰d=5.778×10⁻⁸ K (0.20)

where K is the thermal conductivity of the substrate material. The results are tabulated in Table 2 showing the projected capability of the photothermal detection scheme demonstrated here (see The Transcendental Equation (18) Can Be Solved Using Mathematica 5, Wolfram Research (www.wolfram.com)).

TABLE 2
Smallest size TNT particle that can be detected with
SNR 1 ~ for various substrates for laser power
of 1 W and a scanning spot size of 1 mm diameter.

| Substrate Material | TNT Radius (μm) | TNT Mass | |
|---|---|---|---|
| Brass | 2.3885 | 94 | pg |
| ZnSe | 1.1808 | 11 | pg |
| Stainless Steel (304) | 1.0945 | 9 | pg |
| BaF2, LiF | 1.037355 | 7.7 | pg |
| KCl | 0.647355 | 1.8 | pg |
| Plastic Laminate | 0.2517235 | 110 | fg |
| Silicone | 0.2329225 | 87 | fg |
| Paper | 0.155015 | 26 | fg |

The effect of substrate thermal conductivity is evident in the smallest detectable particle size. It is clear from the Table 2 that in practice (briefcases and clothing), we should be able to reach a detection capability at a sub-picogram levels for any strongly absorbing residue particles from explosives (see Frank Pistera, Michael Halik, Alexander Casteli and Walter Fredericks, “Analysis of Explosives Using Infrared Spectroscopy” Anal. Chem. 32, pp. 495-508 (1960)). No background subtraction was used in this calculation. According to the full matrix background subtraction mentioned below, this estimate is conservative. Also, it is worth pointing out that the technique described here is ideally suited for standoff detection of bulk condensed state explosives at distances in excess of tens of meters by trading the radiating surface area against the detection distance in equation (0.15).

### Experimental Results

Blackbody radiation emitted from selectively heated tiny fragments of absorbers was detected using the equipment setup of FIG. 1. A 1.55 μm DFB diode laser was coupled into an Er doped fiber amplifier and provides a near TEM₀₀ output power of 200 mW. The laser light was gently focused on to a transparent substrate (KCl). A single particle of powdered PbS was selectively deposited on the KCl substrate. An infrared camera that is blind to 1.55 μm radiation but is sensitive in the 8 μm to 12 μm region was focused on the illuminated laser spot. It is very important to blind the camera from the incident laser radiation to assure that none of the laser light that may be scattered by the particles and at the wavelength of the laser light enters the camera. For the proposed longer wavelength lasers required for the TNT detection (see below), appropriate notch rejection filters must be incorporated in front of the camera. We have used FLIR Systems “Model A40 Researcher” IR camera for the measurements described below.

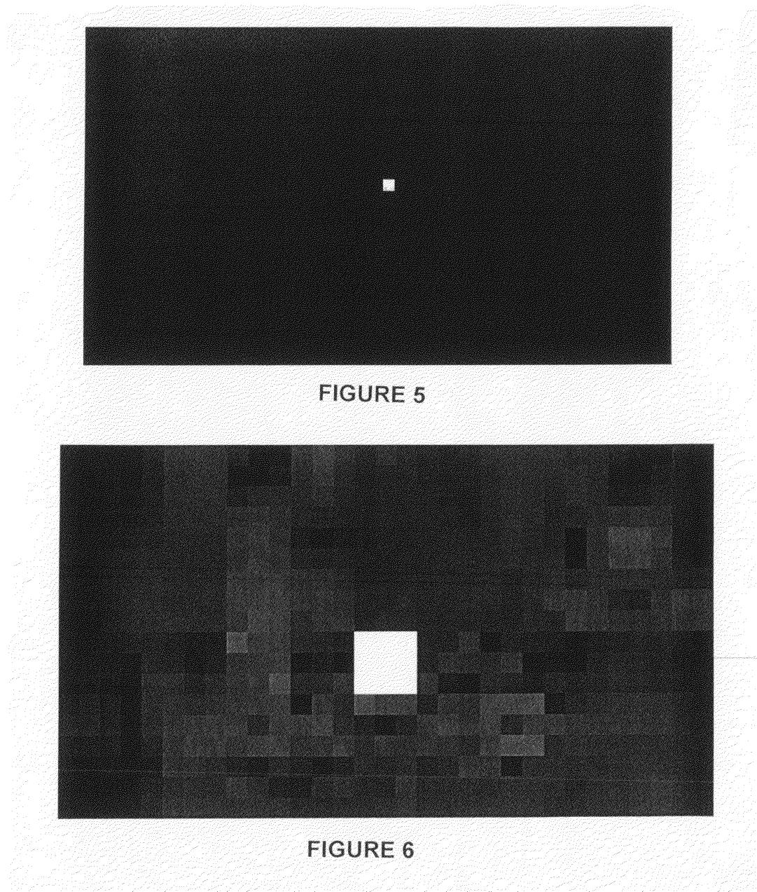

FIG. 5 shows an infrared photograph of a radiating PbS particle on the KCl substrate. The camera pixel size is 38 μm. The blown up picture shown in FIG. 6 indicates that the PbS particle occupies only one pixel of the camera. Thus, we can confidently state that the PbS particle image size is 38 μm. The combination of the camera lens focal length and the distance to the target area (determined by the minimum focusing distance for the lens), results in about 100 cm2 viewing area. Under these circumstances, the image of the PbS sample heated due to the absorption of the laser radiation occupies <1 pixel of the 240×320 pixel focal plane array. Laser power was 200 mW and a 2 mm diameter area was illuminated. The power intercepted by the PbS particle is ˜125 μW. PbS is opaque at 1.55 μm and has an absorption coefficient of ˜30,000 cm⁻¹ at this wavelength (see M. Lax, “Temperature Rise Induced by a Laser Beam” J. Appl. Phys. 48, pp. 3919-3924 (1977). Thus, all of the intercepted radiation was absorbed in the PbS particle.

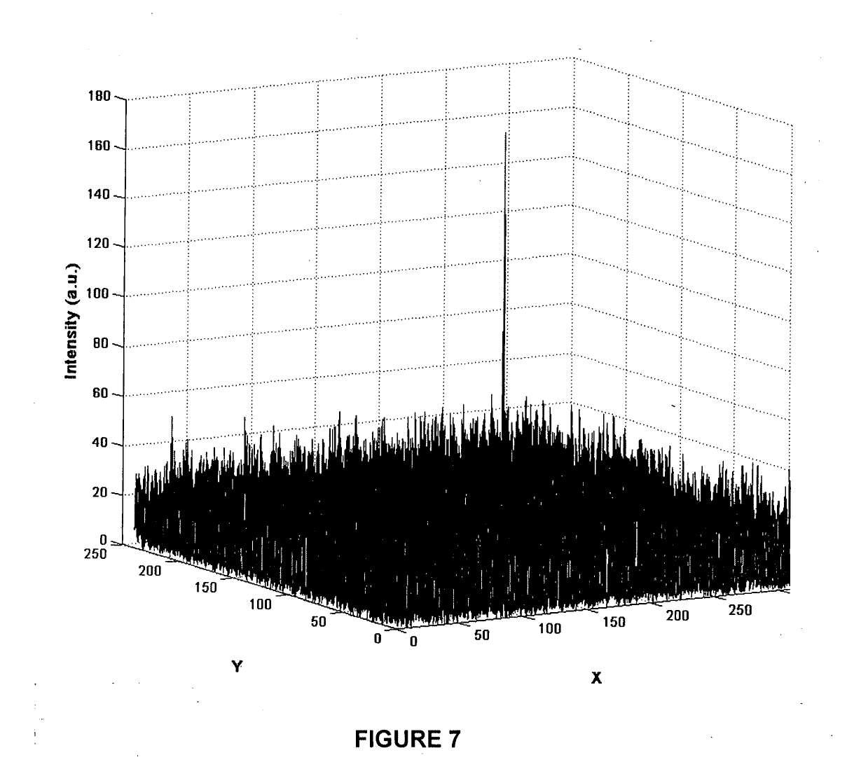

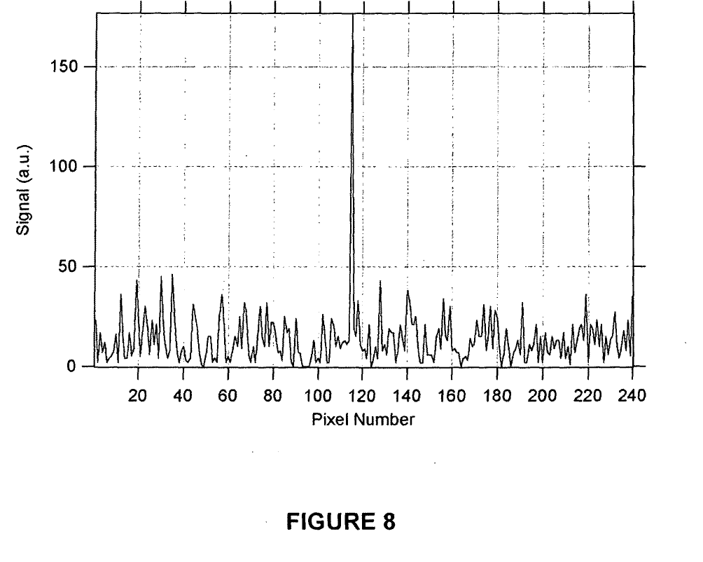

The raw image data as recorded by the camera contains the total black-body radiation from the PbS particle as well as the background thermal radiation from the KCl substrate and its surroundings with different emissivities. All image frames were averaged for 5 seconds at a frame rate of 50 Hz. This unprocessed data showed a peak to background ratio of ˜5. In order to enhance the contrast of the signal from PbS particle we subtracted the background image matrix from the signal+background image matrix. This image subtraction of the average signals, pixel by pixel, reduces the background floor of the image. FIG. 7 shows the three dimensional map of the experimental results when the ˜38 μm diameter PbS particle was illuminated with 1.55 μm laser radiation. This figure shows the experimental results after background subtraction. FIG. 8 shows a line scan of the experimental results shown in FIG. 7 in the x-y plane along the y direction for x=181.

Based on analysis of the background noise, a standard deviation of the noise signal (calculated for all the pixels in the 240×320 array) was found to be 8.6 units on the scale of the figure. With the PbS signal amplitude of ˜176, we deduce a SNR of 20 for the detection of ˜50 μm diameter PbS particle. The mass of the 50 μm PbS particle, which is a very heavy metal compound, is ˜491 nanograms (specific gravity of 7.5). Thus, these studies demonstrate a lowest detection level (LDL) of <25 nanogram of material for a SNR of 1. The wavelength selectivity was checked by exposing the same sample with a 4.6 μm radiation of comparable power (200 mW) and spot size from a quantum cascade laser. (See Arkadily Lyakh, C. Pflugl, L. Diehl, Q. J. Wang, Federico Capasso, X. J. Wang, J. Y. Fan, T. Tanbun-Ek, R. Maulini, A. Tsekoun, R. Go and C. Kumar N. Patel, “1.6 Watt, High Wallplug Efficiency, Continuous-Wave Room Temperature Quantum Cascade Laser Emitting at 4.6 μm” Applied Physics Letters 92, 111110 (2008).) This wavelength, being below the band gap of PbS, the absorption coefficient is only ˜20 cm−1 indicating that the fraction of radiation absorbed by the particle (assuming a spherical particle) is P_{inc}(1−e^{-αl})≈0.076×P_{inc}. (See M. Lax, “Temperature Rise Induced by a Laser Beam” J. Appl. Phys. 48, pp. 3919-3924 (1977).) Thus, the heating and the temperature rise of the PbS sample when illuminated at 4.6 μm would be expected to be smaller than that when it is illuminated the 1.55 μm radiation. The expected SNR from the PbS particle at 4.6 μm wavelength is ˜1.5.

With somewhat higher power tunable lasers that are available in the mid-wave infrared (MWIR) and long-wave infrared (LWIR) regions and higher quality FPA cameras, we expect to improve the capability significantly. (See C. Pflug, L. Diehl, A. Tsekoun, R. Go, C. K. N. Patel, X. Wang, J. Fan, T. Tanbun-Ek and F. Capasso, “Room-Temperature Continuous-Wave Operation of Long Wavelength (I=9.5 mm) MOVPE-Grown Quantum Cascade Lasers” Electronics Letters 43, pp 1025-1026 (2007) and Arkadily Lyakh, C. Pflugl, L. Diehl, Q. J. Wang, Federico Capasso, X. J. Wang, J. Y. Fan, T. Tanbun-Ek, R. Maulini, A. Tsekoun, R. Go and C. Kumar N. Patel, “1.6 Watt, High Wallplug Efficiency, Continuous-Wave Room Temperature Quantum Cascade Laser Emitting at 4.6 μm” Applied Physics Letters 92, 111110 (2008).)

### Comparison to Ion Mobility Spectrometery (IMS) Methods

Current state-of-the-art instruments for detection of explosives used in airports and other sensitive areas throughout the world are predominantly based on ion-mobility spectrometry (IMS). (See K. Cottingham, “Ion Mobility Spectrometry Rediscovered” Product Review, Analytical Chemistry, October 1, p 435A, 2003; R. G. Ewing, D. A. Atkinson, G. A. Eichman and G. J. Ewing, “A Critical Review of Ion Mobility Spectrometry for the Detection of Explosives and Explosive Related Compounds” Talanta 54, pp. 515-529 (2001); and Abu B. kanu, Prabha Dwivedi, Maggie Tam, Laura Matz and Herbert H. Hill, Jr., “Special Feature: Perspective on Ion Mobility-Mass Spectrometry” J. of Mass Spectrometry 43, pp. 1-22 (2008).) These IMS instruments typically consists of a radioactive ion source (⁶³Ni) for atmospheric pressure chemical ionization (APCI) followed by a ion gate for filtering the ions, a drift region through a weak electrostatic field and a Faraday plate where ions are neutralized and the drift-time monitored. This drift-time is a measure of ionic mobility, heavier ions arriving later than lighter ones. A normalized mobility factor K₀ (normalized for 273 K and 760 mm atmospheric pressure) is the standard for comparing measurements of different ions from particles in different instruments. A critical review of IMS for explosives detection is given by Ewing et al. and a recent comprehensive review of ion mobility-mass spectrometry is found in Kanu et al. (See R. G. Ewing, D. A. Atkinson, G. A. Eichman and G. J. Ewing, “A Critical Review of Ion Mobility Spectrometry for the Detection of Explosives and Explosive Related Compounds” Talanta 54, pp. 515-529 (2001) and Abu B. Kanu, Prabha Dwivedi, Maggie Tam, Laura Matz and Herbert H. Hill, Jr., “Special Feature: Perspective on Ion Mobility-Mass Spectrometry” J. of Mass Spectrometry 43, pp. 1-22 (2008).)

Table 3 below provides a comparison between the particle detection method of the present invention and IMS techniques. From Table 3 we see that the method of the present invention offers 10,000 times better selectivity and sensitivity compared to currently used IMS technology. Poor selectivity of IMS can be seen from Tables 2, 3, 4, & 6 of R. G. Ewing, D. A. Atkinson. G. A. Eichman and G. J. Ewing, “A critical review of ion mobility spectrometry for the detection of explosives and explosive related compounds”, Talanta 54, 515-529, (2001), where we see the range of K0 for TNT (Table 2) from 1.41 to 1.60. However this range of K₀ overlaps with that of RDX (Table 3), nitroglycerine & ethylene glycol dinitrate (Table 4) and also the precursor DMNB (2,3-dimethyl-2,3-dinitrobutane). If we take K₀ to be the fingerprint of TNT, then we clearly see that IMS cannot discriminate between the five chemicals mentioned. This is the result of registering common ions and no control over fragmentation of ions.

TABLE 3
A comparison of the capabilities of IMS and current
invention techniques regarding sensitivity, selectivity,
non-contact measurement and hazards.

| | | | Detection using |
|---|---|---|---|
| | | | method of |
| | | | invention |
| Issue | IMS Vapor Tracer¹ | IMS IONSCAN² | (estimates) |
| Sensi- | Cocaine: <30 pg | TNT: 1 ng | TNT < 50 fg |
| tivity | RDX: <50 pg | | RDX < 50 fg |
| | Heroin: <80 pg | | PETN < 50 fg |
| | No TNT data | | |
| Selec- | PFA ~10⁻² | PFA ~10⁻² | PFA ~10⁻⁶ |
| tivity | | | |
| True in- | No (<15 minutes | No (<15 minutes | Yes |
| situ | warm-up and 6-11 s | warm-up and 6-11 s | |
| measure- | recording time) | recording time) | |
| ments | | | |
| Hazards | ⁶³Ni radioactive ion- | ⁶³Ni radioactive ion- | No Hazardous |
| | source | source | materials |
| | Once a year sealing | Once a year sealing | |
| | check | check | |

¹VaporTracer from GE Industrial (www.geindustrial.com/ge-interlogix/iontrack)
²IONSCAN 400B from Smiths Detection (www.smithsdetection.com)

For interference rejection, the use of gas chromatography inlet (which also reduces sensitivity) or a regular mass spectrometer in tandem with an IMS instrument slows down the measurement substantially. These procedures have not been implemented for explosive detection because of a lack of understanding of the ionization chemistry and enhanced power/cost requirements for alternate ionization sources other than the presently used ⁶³Ni plate. This radioactive ionization source requires yearly inspection under Federal law, which also restricts mobility of these instruments due to accidental leak of the radioactive material.

Explosives detection according to the present invention is based on MIR spectroscopy with clearly defined fingerprints for the five elements mentioned above and will discriminate between them since the optical absorption features are entirely different. In contrast with IMS explosives detection, the inventive method and system offers four orders of magnitude higher sensitivity and selectivity (PFA) with no hazardous chemicals allowing full portability. In addition, the inventive technique for explosives detection allows truly real-time measurements, which cannot be expected from IMS based instruments. Also, any instrumentation based on light scattering (such as Raman or Rayleigh) will have a far reduced sensitivity (several orders of magnitude) than the technique of the current invention, as explained in our earlier filed application, entitled Remote Optothermal Sensor (ROSE) Standoff Detection of CWAs, Explosives Vapors and TICs.

It is expected that the inventive technique will afford a detection capability for amounts in the order of picograms of condensed or solid phase material in real world environments. Based on the above experimental data and theoretical analysis, a capability of detecting and identifying isolated and/or individual particles as small as a few nanograms has been demonstrated. Additionally, theoretical analysis indicates that with optimized detectors and data processing algorithms, measurement capability can be improved significantly, permitting nondestructive, noncontact analysis of particles of smaller quantity and size. We also show that with the availability of high power, room temperature, tunable mid wave infrared (MWIR) and long wave infrared (LWIR) lasers, this technology may play an important role in detecting and identifying explosive material residue on persons who may have handled these dangerous materials. (See C. Pflug, L. Diehl, A. Tsekoun, R. Go, C. K. N. Patel, X. Wang, J. Fan, T. Tanbun-Ek and F. Capasso, “Room-Temperature Continuous-Wave Operation of Long Wavelength (I=9.5 mm) MOVPE-Grown Quantum Cascade Lasers” Electronics Letters 43, pp 1025-1026 (2007) and Arkadily Lyakh, C. Pflugl, L. Diehl, Q. J. Wang, Federico Capasso, X. J. Wang, J. Y. Fan, T. Tanbun-Ek, R. Maulini, A. Tsekoun, R. Go and C. Kumar N. Patel, “1.6 Watt, High Wallplug Efficiency, Continuous-Wave Room Temperature Quantum Cascade Laser Emitting at 4.6 μm” Applied Physics Letters 92, 111110 (2008).)

While the present invention has been described with regards to particular embodiments, it is recognized that additional variations of the present invention may be devised without departing from the inventive concept.

What is claimed is:

1. A system for the detection of a target substance wherein the target substance is located or suspected of being located on a surface, comprising:
a laser system capable of generating at least one wavelength of interest for said target substance, said laser system adapted for illuminating said surface with said wavelength of interest;
said wavelength of interest being at or near an absorption wavelength characteristic of said target substance, such that when said surface is illuminated with said wavelength of interest, a significantly noticeable localized temperature increase differential can indicate the presence of said target substance;
a heat sensor adapted for detecting heat generated by said surface after illuminating said surface, such that the presence of said target substance is at least partially detectable in the surface when the surface is illuminated with said wavelength of interest by detecting heat generated with said heat sensor, said heat sensor capable of sensing a temperature change differential between said target substance and said surface.

2. The system of claim 1, said system being capable of detecting the presence or absence of said target substance, identifying said target substance, locating said target substance, and combinations thereof, wherein said target substance is present in an amount of approximately a picogram or greater.

3. The system of claim 1, said target substance including one or more than one constituents, said system capable of detecting at least one of said constituents.

4. The system of claim 1, said laser system including a tunable laser system which is tunable to a plurality of wavelengths including said wavelength of interest.

5. The system of claim 4, said tunable laser system being continuously tunable, tunable to discrete wavelength intervals, or a combination thereof.

6. The system of claim 4, said tunable laser tunable to wavelengths in a range of approximately 2 μm-20 μm.

7. The system of claim 1, said laser system comprising infrared laser in the wavelength range of 2 μm-20 μm.

8. The system of claim 1, wherein said wavelength of interest is in a range of approximately 2 μm-20 μm.

9. The system of claim 1, said laser system being located at a distance of approximately between 1 cm-100 cm from said surface for detection of said target substance.

10. The system of claim 1, said system being capable of detecting a target substance comprising particles of approximately a nanogram or greater.

11. The system of claim 1, said system capable of detecting a target substance comprising traditional explosives such as TNT, PETN and RDX and homemade explosives such as triacetonitriperoxide (TATP) and hexamethylene triperoxide.

12. The system of claim 1, wherein said heat sensor is blinded from incident laser radiation.

13. A method for detecting a substance on a surface, said substance possibly comprising more than one constituent, the method comprising:
a) providing a laser system capable of generating radiation at a first wavelength;
b) illuminating said surface with said first wavelength,
c) determining a thermal response of said surface after illuminating said surface;
d) determining whether said substance or at least one constituent is present on said surface based on said thermal response, wherein the presence of said substance or at least one constituent is indicated by a significantly noticeable localized temperature increase.

14. The system of claim 13, said method comprising determining the presence, identity, location, or combinations thereof of said substance or at least one constituent.

15. The method of claim 13, said first wavelength being a peak absorption wavelength characteristic of said substance or at least one constituent, such that when said surface is illuminated with said first wavelength, a significantly noticeable localized temperature increase differential can indicate the presence of said substance or at least one constituent, generally at a location where the temperature increase is greatest.

16. The method of claim 13, said laser system comprising a tunable laser capable of generating radiation of at least one other wavelength, different from said first wavelength.

17. The method of claim 16, wherein the presence of a substance on said surface is known, and said tunable laser being capable of generating radiation at a plurality of different wavelengths, further comprising:
determining a peak wavelength of absorption of said substance by repeatedly illuminating said surface with different wavelengths and determining the thermal response to each illumination, until said peak wavelength is determined.

18. A method for identifying a substance on a surface, said substance comprising one or more constituents, the method comprising:
a. providing a tunable laser system capable of generating radiation of a plurality of different wavelengths;
b. illuminating said substance with one illuminating wavelength at a time, and determining the thermal response to each illumination until peak absorption is detected, said peak absorption indicating that the illuminating wavelength is a peak wavelength of absorbance of said at least one constituent of said substance;
c. identifying said substance or at least one constituent of said substance based on the determined peak wavelength of absorbance.

19. The method of claim 18 wherein determining the thermal response includes determining a localized temperature increase differential over the illuminated surface.

20. A method for determining the presence of absence of a suspected substance at a location, comprising:
a) providing a laser system capable of generating radiation at a first wavelength, said first wavelength corresponding to an absorption wavelength of said suspected substance;
b) illuminating a surface including said location with said first wavelength;
c) determining a thermal response over said surface after illuminating said surface;
d) determining whether said substance is present based on said thermal response.
